(19) United States
(12) Patent Application Publication
(10) Pub. No.: US 2012/0208919 A1
(43) Pub. Date: Aug. 16, 2012

(54) PNEUMATIC TIRE

(76) Inventors: Carlo Kanz, Mamer (LU); Christian Jean-Marie Kaes, Schrondweiler (LU); Olivio Jean-Baptiste Pagliarini, Consdorf (LU); Marc Weydert, Strassen (LU); Uwe Ernst Frank, Konz (DE)

(21) Appl. No.: 13/027,300

(22) Filed: Feb. 15, 2011

(51) Int. Cl. B60C 1/00

(52) U.S. Cl. 523/156

(57) ABSTRACT

The invention is directed to a pneumatic tire having a tread comprising a vulcanizable rubber composition comprising,
(A) 10 to 40 phr of a polybutadiene rubber having a microstructure comprised of about 96 to about 98 percent cis 1,4-isomeric units, about 1 to about 3 percent trans 1,4-isomeric units and about 0.3 to about 1 percent vinyl 1,2-content; Mn ranging from about 230,000 to about 250,000 with a heterogeneity index ranging from about 1.5/1 to about 2/1, and a Tg ranging from about −104 to about −109° C.;
(B) 60 to 90 phr of a solution polymerized styrene-butadiene rubber functionalized with an alkoxysilane group and a primary amine group;
(C) 60 to 100 phr of silica having a CTAB of between 40 and 525 m²/g, a BET of between 45 and 550 m²/g; and
(D) less than 5 phr of carbon black.

### BACKGROUND OF THE INVENTION

It is highly desirable for tires to have good wet skid resistance, low rolling resistance, and good wear characteristics. It has traditionally been very difficult to improve a tire's wear characteristics without sacrificing its wet skid resistance and traction characteristics. These properties depend, to a great extent, on the dynamic viscoelastic properties of the rubbers utilized in making the tire.

In order to reduce the rolling resistance and to improve the treadwear characteristics of tires, rubbers having a high rebound have traditionally been utilized in making tire tread rubber compounds. On the other hand, in order to increase the wet skid resistance of a tire, rubbers which undergo a large energy loss have generally been utilized in the tire's tread. In order to balance these two viscoelastically inconsistent properties, mixtures of various types of synthetic and natural rubber are normally utilized in tire treads. For instance, various mixtures of styrene-butadiene rubber and polybutadiene rubber are commonly used as a rubbery material for automobile tire treads.

### SUMMARY OF THE INVENTION

The invention is directed to a pneumatic tire having a tread comprising a vulcanizable rubber composition comprising, expressed as parts by weight per 100 parts by weight of elastomer (phr),

(A) 10 to 40 phr of a polybutadiene rubber having a microstructure comprised of about 96 to about 98 percent cis 1,4-isomeric units, about 1 to about 3 percent trans 1,4-isomeric units and about 0.3 to about 1 percent vinyl 1,2-content; a number average molecular weight (Mn) in a range of from about 230,000 to about 250,000 with a heterogeneity index (Mw/Mn) in a range of from about 1.5/1 to about 2/1, and a Tg in a range of from about −104 to about −109° C.;

(B) 60 to 90 phr of a solution polymerized styrene-butadiene rubber functionalized with an alkoxysilane group and a primary amine group, and is represented by the formula (1) or (2)

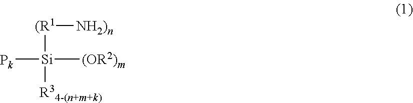

wherein P is a (co)polymer chain of a conjugated diolefin or a conjugated diolefin and an aromatic vinyl compound, R¹ is an alkylene group having 1 to 12 carbon atoms, R² and R³ are each independently an alkyl group having 1 to 20 carbon atoms, an allyl group or an aryl group, n is an integer of 1 or 2, m is an integer of 1 or 2, and k is an integer of 1 or 2, with the proviso that n+m+k is an integer of 3 or 4,

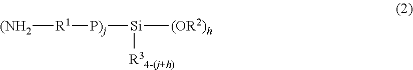

wherein P, R¹, R² and R³ have the same definitions as give for the above-mentioned formula (1), j is an integer of 1 to 3, and h is an integer of 1 to 3, with the provision that j+h is an integer of 2 to 4;

(C) 60 to 100 phr of silica having a CTAB specific surface area (S_{CTAB}) of between 40 and 525 m²/g, a BET specific surface area (S_{BET}) of between 45 and 550 m²/g; and

(D) no more than 5 phr of carbon black.

### DESCRIPTION OF THE INVENTION

There is disclosed a pneumatic tire having a tread comprising a vulcanizable rubber composition comprising, expressed as parts by weight per 100 parts by weight of elastomer (phr),

(A) 10 to 40 phr of a polybutadiene rubber having a microstructure comprised of about 96 to about 98 percent cis 1,4-isomeric units, about 1 to about 3 percent trans 1,4-isomeric units and about 0.3 to about 1 percent vinyl 1,2-content; a number average molecular weight (Mn) in a range of from about 230,000 to about 250,000 with a heterogeneity index (Mw/Mn) in a range of from about 1.5/1 to about 2/1, and a Tg in a range of from about −104 to about −109° C.;

(B) 60 to 90 phr of a solution polymerized styrene-butadiene rubber functionalized with an alkoxysilane group and a primary amine group, and is represented by the formula (1) or (2)

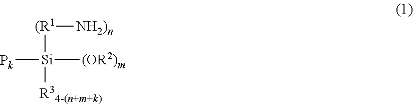

wherein P is a (co)polymer chain of a conjugated diolefin or a conjugated diolefin and an aromatic vinyl compound, R¹ is an alkylene group having 1 to 12 carbon atoms, R² and R³ are each independently an alkyl group having 1 to 20 carbon atoms, an allyl group or an aryl group, n is an integer of 1 or 2, m is an integer of 1 or 2, and k is an integer of 1 or 2, with the proviso that n+m+k is an integer of 3 or 4,

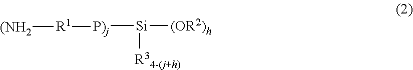

wherein P, R¹, R² and R³ have the same definitions as give for the above-mentioned formula (1), j is an integer of 1 to 3, and h is an integer of 1 to 3, with the provision that j+h is an integer of 2 to 4;

(C) 60 to 100 phr of silica having a CTAB specific surface area (S_{CTAB}) of between 40 and 525 m²/g, a BET specific surface area (S_{BET}) of between 45 and 550 m²/g; and

(D) no more than 5 phr of carbon black.

The phrase “rubber or elastomer containing olefinic unsaturation” is intended to include both natural rubber and its various raw and reclaim forms as well as various synthetic rubbers. In the description of this invention, the terms “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials, and such terms are well known to those having skill in the rubber mixing or rubber compounding art.

One component of the rubber composition is from 10 to 40 phr of a polybutadiene rubber having a microstructure comprised of about 96 to about 98 percent cis 1,4-isomeric units, about 1 to about 3 percent trans 1,4-isomeric units and about 0.3 to about 1 percent vinyl 1,2-content; a number average molecular weight (Mn) in a range of from about 230,000 to about 250,000 with a heterogeneity index (Mw/Mn) in a range of from about 1.5/1 to about 2/1, and a Tg in a range of from about −104 to about −109° C. Suitable polybutadiene is available commercially as Buna CB25® from Lanxess.

A second component of the rubber composition is from 60 to 90 phr of a solution polymerized styrene-butadiene rubber functionalized with an alkoxysilane group a primary amine.

In one embodiment, the styrene-butadiene rubber is obtained by copolymerizing styrene and butadiene, and characterized in that the styrene-butadiene rubber has a primary amino group and an alkoxysilyl group which are bonded to the polymer chain. In one embodiment, the alkoxysilyl group may be at least one of methoxysilyl group and ethoxysilyl group.

The primary amino group may be bonded to any of a polymerization initiating terminal, a polymerization terminating terminal, a main chain of the styrene-butadiene rubber and a side chain, as long as it is bonded to the styrene-butadiene rubber chain. However, the primary amino group is preferably introduced to the polymerization initiating terminal or the polymerization terminating terminal, in that the disappearance of energy at a polymer terminal is inhibited to improve hysteresis loss characteristics.

Further, the content of the alkoxysilyl group bonded to the polymer chain of the (co)polymer rubber is preferably from 0.5 to 200 mmol/kg of (styrene-butadiene rubber. The content is more preferably from 1 to 100 mmol/kg of styrene-butadiene rubber, and particularly preferably from 2 to 50 mmol/kg of styrene-butadiene rubber.

The alkoxysilyl group may be bonded to any of the polymerization initiating terminal, the polymerization terminating terminal, the main chain of the (co)polymer and the side chain, as long as it is bonded to the (co)polymer chain. However, the alkoxysilyl group is preferably introduced to the polymerization initiating terminal or the polymerization terminating terminal, in that the disappearance of energy is inhibited from the (co)polymer terminal to be able to improve hysteresis loss characteristics.

The styrene-butadiene rubber can be produced by polymerizing styrene and butadiene in a hydrocarbon solvent by anionic polymerization using an organic alkali metal and/or an organic alkali earth metal as an initiator, adding a terminating agent compound having a primary amino group protected with a protective group and an alkoxysilyl group to react it with a living polymer chain terminal at the time when the polymerization has substantially completed, and then conducting deblocking, for example, by hydrolysis or other appropriate procedure. In one embodiment, the styrene-butadiene rubber can be produced as disclosed in U.S. Pat. No. 7,342,070.

In one embodiment, and as taught in U.S. Pat. No. 7,342,070, the styrene-butadiene rubber is of the formula (I) or (II)

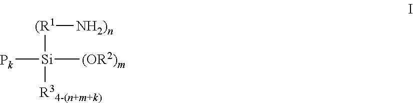

wherein P is a (co)polymer chain of a conjugated diolefin or a conjugated diolefin and an aromatic vinyl compound, R¹ is an alkylene group having 1 to 12 carbon atoms, R² and R³ are each independently an alkyl group having 1 to 20 carbon atoms, an allyl group or an aryl group, n is an integer of 1 or 2, m is an integer of 1 or 2, and k is an integer of 1 or 2, with the proviso that n+m+k is an integer of 3 or 4,

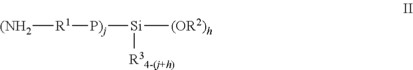

wherein P, R¹, R² and R³ have the same definitions as give for the above-mentioned formula I, j is an integer of 1 to 3, and h is an integer of 1 to 3, with the provision that j+h is an integer of 2 to 4.

The terminating agent compound having a protected primary amino group and an alkoxysilyl group may be any of various compounds as are known in the art. In one embodiment, the compound having a protected primary amino group and an alkoxysilyl group may include, for example, N,N-bis(trimethylsilyl)aminopropylmethyldimethoxysilane, 1-trimethylsilyl-2,2-dimethoxy-1-aza-2-silacyclopentane, N,N-bis(trimethylsilyl)aminopropyltrimethoxysilane, N,N-bis(trimethylsilyl)aminopropyltriethoxysilane, N,N-bis(trimethylsilyl)aminopropylmethyldiethoxysilane, N,N-bis(trimethylsilyl)aminoethyltrimethoxysilane, N,N-bis(trimethylsilyl)-aminoethyltriethoxysilne, N,N-bis(trimethylsilyl)aminoethylmethyldimethoxysilane, N,N-bis(trimethylsilyl)aminoethylmethyldiethoxysilane, etc., and preferred are 1-trimethylsilyl-2,2-dimethoxy-1-aza-2-silacyclopentane, N,N-bis(trimethylsilyl)aminopropylmethyldimethoxysilane and N,N-bis(trimethylsilyl)aminopropylmethyldiethoxysilane. In one embodiment, the compound having a protected primary amino group and an alkoxysilyl group is N,N-bis(trimethylsilyl)aminopropyltriethoxysilane.

In one embodiment, the compound having a protected primary amino group and an alkoxysilyl group may be any compound of formula III

RN—(CH₂)_{X}Si(OR′)₃, III

wherein R in combination with the nitrogen (N) atom is a protected amine group which upon appropriate post-treatment yields a primary amine, R′ represents a group having 1 to 18 carbon atoms selected from an alkyl, a cycloalkyl, an allyl, or an aryl; and X is an integer from 1 to 20. In one embodiment, at least one R group is an ethyl radical. By appropriate post-treatment to yield a primary amine, it is meant that subsequent to reaction of the living polymer with the compound having a protected primary amino group and an alkoxysilyl group, the protecting groups are removed. For example, in the case of bis(trialkylsilyl) protecting group as in N,N-bis(trimethylsilyl)aminopropyltriethoxysilane, hydrolysis is used to remove the trialkylsilyl groups and leave the primary amine.

Suitable solution polymerized styrene-butadiene rubber is available commercially as HPR355H from JSR.

A reference to glass transition temperature, or Tg, of an elastomer or elastomer composition, where referred to herein, represents the glass transition temperature(s) of the respective elastomer or elastomer composition in its uncured state or possibly a cured state in a case of an elastomer composition. A Tg can be suitably determined as a peak midpoint by a differential scanning calorimeter (DSC) at a temperature rate of increase of 10° C. per minute.

The rubber composition may also include from 10 to 60 phr of processing oil. Processing oil may be included in the rubber composition as extending oil typically used to extend elastomers. Processing oil may also be included in the rubber composition by addition of the oil directly during rubber compounding. The processing oil used may include both extending oil present in the elastomers, and process oil added during compounding. In one embodiment, the rubber composition includes a low PCA oil. Suitable low PCA oils include but are not limited to mild extraction solvates (MES), treated distillate aromatic extracts (TDAE), residual aromatic extract (RAE), SRAE, and heavy napthenic oils as are known in the art; see for example U.S. Pat. Nos. 5,504,135; 6,103,808; 6,399,697; 6,410,816; 6,248,929; 6,146,520; U.S. Published Applications 2001/00023307; 2002/0000280; 2002/0045697; 2001/0007049; EP0839891; JP2002097369; ES2122917.

Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

Resins may be used in the rubber composition and are generally present in an amount ranging from about 1 to about 20 phr, with a range of from about 5 to about 20 phr being preferred. Suitable resins include alphamethyl styrene resins, coumarone type resins, including coumarone-indene resins and mixtures of coumarone resins, naphthenic oils, phenol resins, and rosins. Other suitable resins include phenol-terpene resins such as phenol-acetylene resins, phenol-formaldehyde resins, terpene-phenol resins, polyterpene resins, and xylene-formaldehyde resins. Further suitable resins include petroleum hydrocarbon resins such as synthetic polyterpene resins; aromatic hydrocarbon resins; resins resulting from the polymerization of styrene and alphamethyl styrene; aliphatic hydrocarbon resins; aliphatic cyclic hydrocarbon resins, such as dicyclopentadiene resins; aliphatic aromatic petroleum resins; hydrogenated hydrocarbon resins; hydrocarbon tackified resins; aliphatic alicyclic petroleum resins; rosin derivatives; and terpene resins. In one embodiment, the resin is selected from hydrocarbon resins synthesized by cationic polymerization of styrene and alphamethyl styrene, and coumarone-indene resins.

The vulcanizable rubber composition may include from about 60 to about 100 phr of a high structure silica.

The rubber composition includes a high structure silica. By high structure, it is meant that the silica has a relatively high specific surface area. Suitable high structure silica may be produced following the methods of U.S. Publication 2005/0032965. The characterization of the high structure silica is reproduced herein from U.S. Publication 2005/0032965, paragraphs [0055] to [0185].

As disclosed in U.S. Publication 2005/0032965, paragraphs [0055] to [0185]:

In the description of the high structure silica that follows, the BET specific surface area is determined using the Brunauer-Emmet-Teller method described in “The Journal of the American Chemical Society,” Vol. 60, page 309, February 1938 and corresponding to the International Standard ISO 5794/1 (Appendix D).

The CTAB specific surface area is the external surface area determined according to the NF T 45007 (November 1987) (5.12) standard.

The DOP oil uptake is determined according to the NF T 30-022 (March 1953) standard using dioctyl phthalate.

The pH is measured according to the ISO 787/9 standard (the pH of a 5% suspension in water).

The XDC particle size analysis method, using centrifugal sedimentation, by which, on the one hand, the size distribution widths of high structure silica objects and, on the other hand, the XDC mode illustrating its size of objects were measured, is described below.

Equipment Needed:

BI-XDC (Brookhaven Instrument X Disc Centrifuge) centrifugal sedimentation particle size analyser sold by Brookhaven Instrument Corporation;

50 ml tall form beaker;

50 ml graduated measuring cylinder; P1 1500 watt Branson ultrasonic probe, with no endpiece, 13 mm in diameter;

deionized water;

ice-filled crystallizer;

magnetic stirrer.

Measurement Conditions:

DOS 1.35 version of the software (supplied by the manufacturer of the particle size analyser);

fixed mode;

rotation speed;

duration of the analysis: 120 minutes;

density (high structure silica): 2.1;

volume of the suspension to be sampled: 15 ml.

Preparation of the Specimen:

add 3.2 g of high structure silica and 40 ml deionized water to the tall form beaker;

put the beaker containing the suspension in the ice-filled crystallizer;

immerse the ultrasonic probe in the beaker;

disintegrate the suspension for 16 minutes using the 1500 watt Branson probe (used at 60% of maximum power);

after the disintegration, put the beaker on a magnetic stirrer.

Preparation of the Particle Size Analyser:

turn the apparatus on and leave to heat for 30 minutes;

rinse the disc twice with deionized water;

introduce 15 ml of the specimen to be analysed into the disc and start the stirring;

enter into the software the above-mentioned measurement conditions;

make the measurements;

when the measurements have been taken:

stop the disc rotating;

rinse the disc several times with deionized water;

stop the apparatus.

Results

In the apparatus register, record the values of the 16 wt %, 50 wt % (or median) and 84 wt % let-through diameters and the value of the mode (the derivative of the cumulative particle size curve gives a frequency curve the abscissa of the maximum of which (abscissa of the main population) is called the mode).

The size distribution width L_{d} of objects, measured by XDC particle size analysis, after ultrasonic disintegration (in water), corresponds to the (d84−d16)/d50 ratio in which dn is the size for which n % of particles (by weight) have a size smaller than that size (the distribution width L_{d} is therefore calculated from the cumulative particle size curve taken in its entirety).

The size distribution width L′_{d} of objects smaller than 500 nm, measured by XDC particle size analysis, after ultrasonic disintegration (in water), corresponds to the (d84−d16)/d50 ratio in which dn is the size for which n % of particles (by weight), with respect to the particles smaller in size than 500 nm, have a size smaller than that size (the distribution width L′_{d} is therefore calculated from the cumulative particle size curve truncated above 500 nm).

In addition, using this centrifugal sedimentation XDC particle size analysis method, it is possible to measure a weight-average size of the particles (that is to say of the secondary particles or aggregates), denoted d_{w}, after dispersion, by ultrasonic disintegration, of the high structure silica in water. The method differs from that described above by the fact that the suspension formed (high structure silica+deionized water) is disintegrated, on the one hand, for 8 minutes and, on the other hand, using a 1500 watt 1.9 cm VIBRACELL ultrasonic probe (sold by Bioblock) (the probe being used at 60% of maximum power). After analysis (sedimentation for 120 minutes), the weight distribution of particle sizes is calculated by the software of the particle size analyser. The weight-average geometrical mean of the particle sizes (Xg according to the nomenclature of the software), denoted d_{w}, is calculated by the software from the following equatic

$$Log {d}_{w} = {\sum }_{i = 1}^{n} {m}_{i} log {d}_{i} / {\sum }_{i = 1}^{n} {m}_{i}$$

mᵢ being the mass of all of the objects in the class of size dᵢ.

The pore volumes given are measured by mercury porosimetry; each specimen is prepared as follows: each specimen is predried for 2 hours in an oven at 200° C. and then placed in a test container within 5 minutes following its removal from the oven and vacuum-degassed, for example using a rotary vane pump; the pore diameters (AUTOPORE III 9420 Micromeritics porosimeter) are calculated by the Washburn equation with a contact angle θ of 140° and a surface tension γ of 484 dynes/cm (or N/m).

V_{(d5-d50)} represents the pore volume formed by the pores of diameters between d5 and d50 and V_{(d5-d100)} represents the pore volume formed by the pores of diameters between d5 and d100, do here being the pore diameter for which n % of the total surface area of all the pores is formed by the pores of diameter greater than that diameter (the total surface area of the pores (S₀) may be determined from the mercury intrusion curve).

The pore distribution width ldp is obtained by the pore distribution curve, as indicated in FIG. 1 of U.S. Publication 2005/0032965, i.e., the pore volume (in ml/g) as a function of the pore diameter (in nm): the coordinates of the point S corresponding to the principal population, namely the values of the diameter X_{S} (in nm) and the pore volume Y_{S} (in ml/g), are recorded; a straight line of the equation Y=Y_{S}/2 is plotted; this straight line cuts the pore distribution curve at two points A and B on either side of X_{S}, the abscissae (in nm) of points A and B being X_{A} and X_{B}, respectively; the pore distribution width pdw is equal to the ratio (X_{A}−X_{B})/X_{S}.

In some cases, the dispersibility (and disintegratability) of the high structure silica according to the invention may be quantified by means of specific disintegration tests.

One of the disintegration tests is carried out according to the following protocol:

The cohesion of the agglomerates is assessed by a particle size measurement (using laser diffraction) carried out on a suspension of high structure silica ultrasonically disintegrated beforehand; in this way, the disintegratability of the high structure silica (the break-up of objects from 0.1 to a few tens of microns) is measured.

The ultrasonic disintegration is carried out using a Bioblock Vibracell sonifier (600-W) fitted with a 19 mm diameter probe. The particle size measurement is carried out by laser diffraction on a SYMPATEC particle size analyser.

Weighed in a pillbox (height: 6 cm and diameter: 4 cm) are 2 grams of high structure silica to which 50 grams of deionized water are added: an aqueous suspension containing 4% high structure silica, which is homogenized for 2 minutes by magnetic stiffing, is thus produced. Next, the ultrasonic disintegration is carried out as follows: with the probe immersed over a length of 4 cm, the output power is adjusted so as to obtain a deflection of the needle of the power dial indicating 20%. The disintegration is carried out for 420 seconds. Next, the particle size measurement is taken after a known volume (expressed in ml) of the homogenized suspension has been introduced into the container of the particle size analyser.

The value of the median diameter Ø_{50S} (or Sympatec median diameter) that is obtained is smaller the higher the disintegratability of the high structure silica. It is also possible to determine the (10× volume of suspension (in ml) introduced)/(optical density of the suspension detected by the particle size analyser) ratio may also be determined (this optical density is around 20). This ratio is indicative of the content of particles of a size of less than 0.1 μm, which particles are not detected by the particle size analyser. This ratio is called the ultrasonic Sympatec disintegration factor (F_{DS}).

Another disintegration test is carried out according to the following protocol:

The cohesion of the agglomerates is assessed by a particle size measurement (using laser diffraction) carried out on a suspension of high structure silica ultrasonically disintegrated beforehand; in this way, the disintegrability of the high structure silica (break-up of objects from 0.1 to a few tens of microns) is measured. The ultrasonic disintegration is carried out using a Bioblock VIBRACELL sonifier (600 W), used at 80% of maximum power, fitted with a 19 mm diameter probe. The particle size measurement is carried out by laser diffraction on a Malvern Mastersizer 2000 particle size analyser.

1 gram of high structure silica is weighed in a pillbox (height: 6 cm and diameter: 4 cm) and deionized water is added to bring the weight to 50 grams: an aqueous suspension containing 2% high structure silica, which is homogenized for 2 minutes by magnetic stiffing, is thus produced. Ultrasonic disintegration is then carried out for 420 seconds. Next, the particle size measurement is taken after all of the homogenized suspension has been introduced into the container of the particle size analyser.

The value of the median diameter Ø_{50M} (or Malvern median diameter) that is obtained is smaller the higher the disintegratability of the high structure silica. It is also possible to determine the (10× blue laser obscuration value)/(red laser obscuration value) ratio. This ratio is indicative of the content of particles smaller in size than 0.1 μm. This ratio is called the Malvern ultrasonic disintegration factor (F_{DM}).

A disintegration rate, denoted α, may be measured by means of another ultrasonic disintegration test, at 100% power of a 600 watt probe, operating in pulsed mode (i.e.: on for 1 second/off for 1 second) so as to prevent the ultrasonic probe from heating up excessively during the measurement. This known test, forming the subject matter for example of Application WO 99/28376 (see also Applications WO 99/28380, WO 00/73372 and WO 00/73373), allows the variation in the volume-average size of the particle agglomerates to be continuously measured during sonification, according to the indications given below. The set-up used consists of a laser particle size analyser (of the MASTERSIZER S type sold by Malvern Instruments: He—Ne laser source emitting in the red at a wavelength of 632.8 nm) and of its preparation station (Malvern Small Sample Unit MSX1), between which a continuous flux stream treatment cell (Bioblock M72410) fitted with an ultrasonic probe (600 watt VIBRACELL-type 12.7 mm sonifier sold by Bioblock) was inserted. A small quantity (150 mg) of high structure silica to be analysed is introduced with 160 ml of water into the preparation station, the rate of circulation being set at its maximum. At least three consecutive measurements are carried out in order to determine, using the known Fraunhofer calculation method (Malvern 3$$D calculation matrix), the initial volume-average diameter of the agglomerates, denoted d_{v[}0]. Sonification (pulsed mode: on for 1 s/off for 1 s) is then applied at 100% power (i.e., 100% of the maximum position of the tip amplitude) and the variation in the volume-average diameter dᵥ[t] as a function of time t is monitored for about 8 minutes, a measurement being taken approximately every 10 seconds. After an induction period (about 3-4 minutes), it is observed that the inverse of the volume-average diameter 1/dᵥ[t] varies linearly, or substantially linearly, with time t (disintegration steady state). The rate of disintegration .alpha. is calculated by linear regression from the curve of variation of 1/dᵥ[t] as a function of time t in the disintegration steady state region (in general, between 4 and 8 minutes approximately); it is expressed in μm⁻¹min⁻¹.

The aforementioned Application WO 99/28376 describes in detail a measurement device that can be used for carrying out this ultrasonic disintegration test. This device consists of a closed circuit in which a stream of particle agglomerates in suspension in a liquid can circulate. This device essentially comprises a specimen preparation station, a laser particle size analyser and a treatment cell. Setting to atmospheric pressure, within the specimen preparation station and the actual treatment cell, makes it possible for the air bubbles that form during sonification (i.e., the action of the ultrasonic probe) to be continuously removed. The specimen preparation station (Malvern Small Sample Unit MSX1) is designed to receive the high structure silica specimen to be tested (in suspension in the liquid) and to make it circulate around the circuit at the preset speed (potentiometer-maximum speed about 3 l/min) in the form of a stream of liquid suspension. This preparation station simply consists of a receiving container which contains the suspension to be analysed and through which the said suspension flows. It is equipped with a variable-speed stirring motor so as to prevent any sedimentation of the particle agglomerates of the suspension, a centrifuge mini-pump is designed to circulate the suspension in the circuit; the inlet of the preparation station is connected to the open air via an opening intended to receive the charge specimen to be tested and/or the liquid used for the suspension. Connected to the preparation station is a laser particle size analyser (MASTERSIZER S) whose function is to continuously measure, at regular time intervals, the volume-average size dᵥ of the agglomerates, as the stream passes, by a measurement cell to which the recording means and the automatic calculation means of the particle size analyser are coupled. It will be briefly recalled here that laser particle size analysers make use, in a known manner, of the principle of light diffraction by solid objects in suspension in a medium whose refractive index is different from that of the solid. According to the Fraunhofer theory, there is a relationship between the size of the object and the angle of diffraction of the light (the smaller the object the larger the angle of diffraction). In practice, all that is required is to measure the quantity of diffracted light for various angles of diffraction in order to be able to determine the size distribution (by volume) of the specimen, dᵥ corresponding to the volume-average size of this distribution dᵥ=Σ(nᵢdᵢ⁴)/Σ(nᵢdᵢ³) where nᵢ is the number of objects of the class of size or diameter dᵢ. Finally, a treatment cell fitted with an ultrasonic probe is inserted between the preparation station and the laser particle size analyser, the said cell being able to operate in continuous or pulsed mode and intended to continuously break up the particle agglomerates as the stream passes. This stream is thermostatically controlled by means of a cooling circuit placed, within the cell, in a jacket surrounding the probe, the temperature being controlled, for example, by a temperature probe immersed in the liquid within the preparation station.

The Sears number is determined using the method described by G. W. Sears in the article in Analytical Chemistry, Vol. 28, No. 12, December 1956 entitled “Determination of specific surface area of colloidal high structure silica by titration with sodium hydroxide.”

The Sears number is the volume of 0.1M sodium hydroxide solution needed to raise the pH of a 10 g/l high structure silica suspension in a 200 g/l sodium chloride medium from 4 to 9.

To do this, 400 grams of sodium chloride are used to prepare a 200 g/l sodium chloride solution acidified to pH 3 with a 1M hydrochloric acid solution. The weighings are performed by means of a Mettler precision balance. 150 ml of this sodium chloride solution are delicately added to a 250 ml beaker into which a mass M (in g) of the specimen to be analysed, corresponding to 1.5 grams of dry high structure silica, has been introduced beforehand. Ultrasound is applied for 8 minutes to the dispersion obtained (Branson 1500 W ultrasonic probe; 60% amplitude, 13 mm diameter), the beaker being in an ice-filled crystallizer. The solution obtained is then homogenized by magnetic stiffing, using a bar magnet having dimensions of 25 mm×5 mm. A check is made that the pH of the suspension is less than 4, if necessary by adjusting it using a 1M hydrochloric acid solution. Next, a 0.1M sodium hydroxide solution is added at a rate of 2 ml/min by means of a Metrohm titrator pH meter (672 Titroprocessor, 655 Dosimat) precalibrated using pH 7 and pH 4 buffer solutions. (The titrator pH meter was programmed as follows: 1) Call up the “Get pH” program- and 2) Introduce the following parameters: pause (wait time before the start of titration): 3 s; reactant flow rate: 2 ml/min; anticipation (adaptation of the titration rate to the slope of the pH curve): 30; stop pH: 9.40; critical EP (sensitivity of detection of the equivalence point): 3; report (parameters for printing the titration report): 2, 3 and 5 (i.e. creation of a detailed report, list of measurement points and titration curve)). The exact volumes V₁ and V₂ of sodium hydroxide solution added in order to obtain a pH of 4 and a pH of 9, respectively, are determined by interpolation. The Sears number for 1.5 grams of dry high structure silica is equal to ((V₂−V_{.sub.}1)×150)/(SC−M), where:

V₁: volume of 0.1M sodium hydroxide solution at pH₁=4;

V₂: volume of 0.1M sodium hydroxide solution at pH₂=9;

M: mass of the specimen (in g);

SC: solids content (in %).

The pore distribution width may possibly be also illustrated by the parameter W/FI determined by mercury porosimetry. The measurement is carried out using PASCAL 140 and PASCAL 440 porosimeters sold by ThermoFinnigan, operating in the following manner: a quantity of specimen between 50 and 500 mg (in the present case 140 mg) is introduced into a measurement cell. This measurement cell is installed in the measurement unit of the PASCAL-140 apparatus. The specimen is then vacuum-degassed for the time needed to achieve a pressure of 0.01 kPa (typically around 10 minutes). The measurement cell is then filled with mercury. The first part of the mercury intrusion curve Vp=f(P), where Vp is the mercury intrusion volume and P is the applied pressure, for pressures of less than 400 kPa, is determined using the PASCAL 140 porosimeter. The measurement cell is then installed in the measurement unit of the PASCAL 440 porosimeter, the second part of the mercury intrusion curve Vp=f(P) for pressures between 100 kPa and 400 MPa being determined using the PASCAL 440 porosimeter. The porosimeters are used in PASCAL mode so as to permanently adjust the rate of mercury intrusion according to the variations in the intrusion volume. The rate parameter in PASCAL mode is set to 5. The pore radii Rp are calculated from the pressure values P using the Washburn equation, assuming that the pores are cylindrical, choosing a contact angle θ of 140° and a surface tension γ of 480 dynes/cm (or N/m). The pore volumes Vp are relative to the mass of high structure silica introduced and are expressed in cm³/g. The signal Vp=f(Rp) is smoothed by combining a logarithmic filter (“smooth dumping factor” filter parameter F=0.96) and a moving-average filter (“number of points to average” filter parameter f=20). The pore size distribution is obtained by calculating the derivative dVp/dRp of the smooth intrusion curve. The fineness index FI is the pore radius value (expressed in angstroms) corresponding to the maximum of the pore size distribution dVp/dRp. The mid-height width of the pore size distribution dVp/dRp is denoted by W.

The number of silanols per nm² of surface area is determined by grafting methanol onto the surface of the high structure silica. Firstly, 1 gram of raw high structure silica is put into suspension in 10 ml of methanol, in a 110 ml autoclave (Top Industrie, reference 09990009). A bar magnet is introduced and the autoclave, hermetically sealed and thermally insulated, is heated to 200° C. (40 bar) on a magnetic stirrer, heating for 4 hours. The autoclave is then cooled in a cold water bath. The grafted high structure silica is recovered by settling and the residual methanol is evaporated in a stream of nitrogen. Finally, the grafted high structure silica is vacuum dried for 12 hours at 130° C. The carbon content is determined by an elemental analyser (NCS 2500 analyser from CE Instruments) on the raw high structure silica and on the grafted high structure silica. This quantitative determination is carried out on the grafted high structure silica within the three days following the end of drying—this is because the humidity of the air or heat may cause hydrolysis of the methanol grafting. The number of silanols per nm.sup.2 is then calculated using the following formula:

N_{SiOH/nm2}=[(% C_{g}−% Cᵣ)×6.023×10²³]/[S_{BET}×10¹⁸×12×100]

where

% C_{g}: percent mass of carbon present on the grafted high structure silica;

% Cᵣ: percent mass of carbon present on the raw high structure silica;

S_{BET}: BET specific surface area of high structure silica (in m²/g).

According to a first variant of the invention, a novel high structure silica will now be proposed which is characterized in that it possesses:

a CTAB specific surface area (S_{CTAB}) of between 40 and 525 m²/g;

a BET specific surface area (S_{BET}) of between 45 and 550 m²/g;

a size distribution width L_{d} ((d84−d16)/d50) of objects measured by XDC particle size analysis after ultrasonic disintegration of at least 0.91, in particular at least 0.94, and

a pore volume distribution as a function of the size of the pores such that the ratio V_{(d5-d50)}/V_{(d5-d100)} is at least 0.66, in particular at least 0.68.

The high structure silica according to this variant of the invention possesses, for example:

a size distribution width L_{d} ((d84−d16)/d50) of objects measured by XDC particle size analysis after ultrasonic disintegration of at least 1.04; and

a pore volume distribution as a function of the size of the pores such that the ratio V_{(d5-d50)}/V_{(d5-d100)} is at least 0.71.

This high structure silica may have a ratio V_{(d5-d50)}/V_{(d5-d100)} of at least 0.73, in particular at least 0.74. This ratio may be at least 0.78, especially at least 0.80 or even at least 0.84.

A second variant of the invention consists of a novel high structure silica characterized in that it possesses:

a CTAB specific surface area (S_{CTAB}) of between 40 and 525 m²/g;

a BET specific surface area (S_{BET}) of between 45 and 550 m²/g; and

a pore distribution width ldp of greater than 0.70, in particular greater than 0.80, especially greater than 0.85.

This high structure silica may have a pore distribution width ldp of greater than 1.05, for example greater than 1.25 or even greater than 1.40.

The high structure silica according to this variant of the invention preferably possesses a size distribution width L_{.sub.}d ((d84−d16)/d50) of objects measured by XDC particle size analysis after ultrasonic disintegration, of at least 0.91, in particular at least 0.94, for example at least 1.0.

Also proposed, according to a third variant of the invention, is a novel high structure silica characterized in that it possesses:

a CTAB specific surface area (S_{CTAB}) of between 40 and 525 m²/g;

a BET specific surface area (S_{BET}) of between 45 and 550 m²/g;

a size distribution width L′_{d} ((d84−d16)/d50) of objects smaller than 500 nm, measured by XDC particle size analysis after ultrasonic disintegration, of at least 0.95; and

a pore volume distribution as a function of the size of the pores such that the ratio V_{(d5-d50)}/V_{(d5-d100)} is at least 0.71.

This high structure silica may have a ratio V_{(d5-d50)}/V_{(d5-d100)} of at least 0.73, in particular at least 0.74. This ratio may be at least 0.78, especially at least 0.80 or even at least 0.84.

A fourth variant of the invention consists of a novel high structure silica characterized in that it possesses:

a CTAB specific surface area (S_{CTAB}) of between 40 and 525 m²/g;

a BET specific surface area (S_{BET}) of between 45 and 550 m²/g;

a size distribution width L_{d} ((d84−d16)/d50) of objects smaller than 500 nm, measured by XDC particle size analysis after ultrasonic disintegration, of at least 0.90, in particular at least 0.92; and

a pore volume distribution as a function of 25 the size of the pores such that the ratio V_{(d5-d50)}/V_{(d5-d100)} is at least 0.74.

This high structure silica may have a ratio V_{(d5-d50)}/V_{(d5-d100)} of at least 0.78, especially at least 0.80 or even at least 0.84.

In the high structure silica according to the invention (that is to say those in accordance with one of the four variants of the invention), the pore volume provided by the coarsest pores usually represents the largest proportion of the structure.

The high structure silica may have both an object size distribution width L_{d} of at least one 1.04 and an object size (smaller than 500 nm) distribution width L′_{d} of at least 0.95.

The size distribution width L_{d} of objects of the high structure silica according to the invention may in certain cases be at least 1.10, in particular at least 1.20; it may be at least 1.30, for example at least 1.50 or even at least 1.60.

Likewise, the object size (smaller than 500 nm) distribution L′_{d} of the high structure silica according to the invention may be, for example, at least 1.0, in particular at least 1.10 and especially at least 1.20.

Preferably, the high structure silica according to the invention possess a particular surface chemistry such that they have a (Sears number×1000)/(BET specific surface area (S_{BET})) ratio of less than 60, preferably less than 55, for example less than 50.

The high structure silica according to the invention generally have a high, and therefore a typical object size which may be such that the mode of their particle size distribution measured by XDC particle size analysis after ultrasonic disintegration (in water) satisfies the condition: XDC mode (nm)≧(5320/S_{CTAB} (m²/g))+8, or even the condition: XDC mode (in nm)≧(5320/S_{CTAB} (m²/g))+10.

The high structure silica according to the invention may possess, for example, a pore volume (V₈₀) formed by the pores having diameters between 3.7 and 80 nm of at least 1.35 cm³/g, in particular at least 1.40 cm³/g or even at least 1.50 cm³/g.

The high structure silica according to the invention preferably have a satisfactory dispersibility in polymers.

Their median diameter (Ø_{50S}), after ultrasonic disintegration, is in general less than 8.5 μm; it may be less than 6.0 μm, for example less than 5.5 μm.

Likewise, their median diameter (Ø_{50M}), after ultrasonic disintegration, is in general less than 8.5 μm, it may be less than 6.0 μm, for example less than 5.5 μm.

They may also possess a rate of disintegration, denoted by α, measured in the test referred to previously as ultrasonic disintegration in pulsed mode, at 100% power of a 600 watt probe, of at least 0.0035 μm⁻¹min⁻¹, in particular at least 0.0037 μm⁻¹min⁻¹.

The high structure silica according to the invention may have an ultrasonic disintegration factor (F_{DS}) of greater than 3 ml, in particular greater than 3.5 ml, especially greater than 4.5 ml.

Their ultrasonic disintegration factor (F_{DM}) may be greater than 6, in particular greater than 7, especially greater than 11.

The high structure silica according to the present invention may have a weight-average particle size, measured by XDC particle size analysis after ultrasonic disintegration, d.sub.w, of between 20 and 300 nm, especially between 30 and 300 nm, for example between 40 and 160 nm.

In general, the high structure silica according to the present invention also have at least one, or even all, of the following three characteristics:

a particle size distribution such that d_{w}≧(16,500/S_{CTAB})−30;

a porosity such that W/FI≧−0.0025 S_{CTAB}+0.85; and

a number of silanols per unit area, N_{SiOH/nm2}, such that N_{SiOH/nm2}≦−0.027 S_{CTAB}+10.5.

According to one embodiment, the high structure silica according to the invention generally have:

a CTAB specific surface area (S_{CTAB}) of between 60 and 330 m²/g, in particular between 80 and 290 m²/g;

a BET specific surface area (S_{BET}) of between 70 and 350 m²/g, in particular between 90 and 320 m²/g.

Their CTAB specific surface area may be between 90 and 230 m²/g, especially between 95 and 200 m²/g, for example between 120 and 190 m²/g.

Likewise, their BET specific surface area may be between 110 and 270 m²/g, especially between 115 and 250 m²/g, for example between 135 and 235 m²/g.

According to another embodiment, the high structure silica according to the invention generally have:

a CTAB specific surface area of between 40 and 380 m²/g, in particular between 45 and 280 m²/g; and

a BET specific surface area of between 45 and 400 m²/g, in particular between 50 and 300 m²/g.

Their CTAB specific surface area may be between 115 and 260 m²/g, especially between 145 and 260 m²/g.

Likewise, their BET specific surface area may be between 120 and 280 m²/g, especially between 150 and 280 m²/g, and more especially between 200 and 260 m²/g.

The high structure silica according to the present invention may have a certain microporosity; thus, the high structure silica according to the invention usually are such that (S_{BET}−S_{CTAB})≧5 m²/g, in particular ≧15 m²/g, for example ≧25 m²/g.

This microporosity is not in general too great: the high structure silica according to the invention are generally such that (S_{BET}−S_{CTAB})<50 m²/g, preferably <40 m²/g.

The pH of the high structure silica according to the invention is usually between 6.3 and 7.8, especially between 6.6 and 7.5.

They possess a DOP oil uptake that varies, usually, between 220 and 330 ml/100 g, for example between 240 and 300 ml/100 g.

They may be in the form of approximately spherical beads with a mean size of at least 80 μM.

This mean size of the beads may be at least 100 μm, for example at least 150 μm; it is in general at most 300 μm and preferably lies between 100 and 270 μm. This mean size is determined according to the NF X 11507 (December 1970) standard by dry screening and determination of the diameter corresponding to a cumulative oversize of 50%.

The high structure silica according to the invention may also be in the form of powder having a mean size of at least 15 μm; for example, it is between 15 and 60 μm (especially between 20 and 45 μm) or between 30 and 150 μm (especially between 45 and 120 μm).

They may also be in the form of granules having a size of at least 1 mm, in particular between 1 and 10 mm, along the axis of their largest dimension (length).

The high structure silica according to the invention are preferably prepared by the preparation process according to the invention and described above.

The rubber composition is generally devoid of carbon black as a reinforcing agent; reinforcement of the rubber composition is obtained through the use of silica. However, some carbon black may be present due to impurities in various additives or from residue present in equipment used in processing of the rubber composition. Small amounts of carbon black may also be introduced to the rubber composition as a carrier for an additive; for example, silane coupling agents may be added as a composite of coupling agent on a carbon black carrier. In one embodiment, the rubber composition contains no more than 5 phr of carbon black. In one embodiment, the rubber composition contains no more than 2 phr of carbon black. In one embodiment, the rubber composition contains no more than 1 phr of carbon black.

The vulcanizable rubber composition may include from 1 to 20 phr of crosslinked particulate polymer gel, ultra high molecular weight polyethylene (UHMWPE) or plasticized starch.

Other fillers may be used in the rubber composition including, but not limited to, particulate fillers including ultra high molecular weight polyethylene (UHMWPE), particulate polymer gels including but not limited to those disclosed in U.S. Pat. No. 6,242,534; 6,207,757; 6,133,364; 6,372,857; 5,395,891; or 6,127,488, and plasticized starch composite filler including but not limited to that disclosed in U.S. Pat. No. 5,672,639.

In one embodiment the rubber composition for use in the tire tread may contain a conventional sulfur containing organosilicon compound. Examples of suitable sulfur containing organosilicon compounds are of the formula:

Z-Alk-Sₙ-Alk-Z I

in which Z is selected from the group consisting of

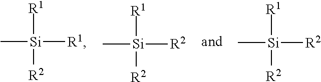

where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl)disulfide, 3,3′-bis(triethoxysilylpropyl)disulfide, 3,3′-bis(triethoxysilylpropyl)tetrasulfide, 3,3′-bis(triethoxysilylpropyl)octasulfide, 3,3′-bis(trimethoxysilylpropyl)tetrasulfide, 2,2′-bis(triethoxysilylethyl)tetrasulfide, 3,3′-bis(trimethoxysilylpropyl)trisulfide, 3,3′-bis(triethoxysilylpropyl)trisulfide, 3,3′-bis(tributoxysilylpropyl)disulfide, 3,3′-bis(trimethoxysilylpropyl)hexasulfide, 3,3′-bis(trimethoxysilylpropyl)octasulfide, 3,3′-bis(trioctoxysilylpropyl)tetrasulfide, 3,3′-bis(trihexoxysilylpropyl)disulfide, 3,3′-bis(tri-2″-ethylhexoxysilylpropyl)trisulfide, 3,3′-bis(triisooctoxysilylpropyl)tetrasulfide, 3,3′-bis(tri-t-butoxysilylpropyl)disulfide, 2,2′-bis(methoxy diethoxy silyl ethyl)tetrasulfide, 2,2′-bis(tripropoxysilylethyl)pentasulfide, 3,3′-bis(tricyclonexoxysilylpropyl)tetrasulfide, 3,3′-bis(tricyclopentoxysilylpropyl)trisulfide, 2,2′-bis(tri-2″-methylcyclohexoxysilylethyl)tetrasulfide, bis(trimethoxysilylmethyl)tetrasulfide, 3-methoxy ethoxy propoxysilyl 3′-diethoxybutoxy-silylpropyltetrasulfide, 2,2′-bis(dimethyl methoxysilylethyl)disulfide, 2,2′-bis(dimethyl sec.butoxysilylethyl)trisulfide, 3,3′-bis(methyl butylethoxysilylpropyl)tetrasulfide, 3,3′-bis(di t-butylmethoxysilylpropyl)tetrasulfide, 2,2′-bis(phenyl methyl methoxysilylethyl)trisulfide, 3,3′-bis(diphenyl isopropoxysilylpropyl)tetrasulfide, 3,3′-bis(diphenyl cyclohexoxysilylpropyl)disulfide, 3,3′-bis(dimethyl ethylmercaptosilylpropyl)tetrasulfide, 2,2′-bis(methyl dimethoxysilylethyl)trisulfide, 2,2′-bis(methyl ethoxypropoxysilylethyl)tetrasulfide, 3,3′-bis(diethyl methoxysilylpropyl)tetrasulfide, 3,3′-bis(ethyl di-sec. butoxysilylpropyl)disulfide, 3,3′-bis(propyl diethoxysilylpropyl)disulfide, 3,3′-bis(butyl dimethoxysilylpropyl)trisulfide, 3,3′-bis(phenyl dimethoxysilylpropyl)tetrasulfide, 3-phenyl ethoxybutoxysilyl 3′-trimethoxysilylpropyl tetrasulfide, 4,4′-bis(trimethoxysilylbutyl)tetrasulfide, 6,6′-bis(triethoxysilylhexyl)tetrasulfide, 12,12′-bis(triisopropoxysilyldodecyl)disulfide, 18,18′-bis(trimethoxysilyloctadecyl)tetrasulfide, 18,18′-bis(tripropoxysilyloctadecenyl)tetrasulfide, 4,4′-bis(trimethoxysilyl-buten-2-yl)tetrasulfide, 4,4′-bis(trimethoxysilylcyclohexylene)tetrasulfide, 5,5′-bis(dimethoxymethylsilylpentyl)trisulfide, 3,3′-bis(trimethoxysilyl-2-methylpropyl)tetrasulfide, 3,3′-bis(dimethoxyphenylsilyl-2-methylpropyl)disulfide.

In one embodiment, the sulfur containing organosilicon compounds are the 3,3′-bis(trimethoxy or triethoxy silylpropyl) sulfides. In one embodiment, the sulfur containing organosilicon compounds are 3,3′-bis(triethoxysilylpropyl)disulfide and 3,3′-bis(triethoxysilylpropyl)tetrasulfide. Therefore, as to formula I, Z may be

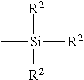

where R² is an alkoxy of 2 to 4 carbon atoms, alternatively 2 carbon atoms; alk is a divalent hydrocarbon of 2 to 4 carbon atoms, alternatively with 3 carbon atoms; and n is an integer of from 2 to 5, alternatively 2 or 4.

In another embodiment, suitable sulfur containing organosilicon compounds include compounds disclosed in U.S. Pat. No. 6,608,125. As disclosed in U.S. Pat. No. 6,608,125, these sulfur containing organosilicon compounds are of the formula G-C(══O)—S—CH₂CH₂CH₂SiX₃ wherein each X is an independently selected RO— group wherein each R is independently selected from the group consisting of hydrogen, alkyl that may or may not contain unsaturation, alkenyl groups, aryl groups, and aralkyl groups, such moieties other than hydrogen having from 1 to 18 carbon atoms, and G is a monovalent alkyl of from 6 to 8 carbon atoms. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from GE Silicones.

In another embodiment, suitable sulfur containing organosilicon compounds include those disclosed in U.S. Patent Publication 2003/0130535. As disclosed in U.S. Patent Publication 2003/0130535, these sulfur containing organosilicon compounds are of the formulas II or III

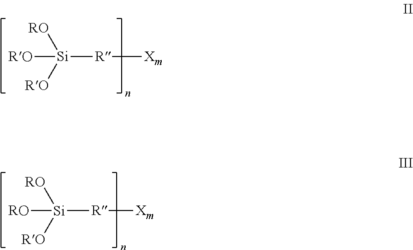

wherein: R is a methyl or ethyl group;

R′ is identical or different and is a C₉C₃₀ branched or unbranched monovalent alkyl or alkenyl group, aryl group, aralkyl group, branched or unbranched C₂-C₃₀ alkyl ether group, branched or unbranched C₂-C₃₀ alkyl polyether group or R′″₃Si, where R′″ is C₁-C₃₀ branched or unbranched alkyl or alkenyl group, aralkyl group or aryl group, R″ is a branched or unbranched, saturated or unsaturated, aliphatic, aromatic or mixed aliphatic/aromatic divalent C₁-C₃₀ hydrocarbon group;

X is SH where n=1 and m=1, S where n=2 and m=1-10 and mixtures thereof, S(C══O)—R′″ where n=1 and m=1 or H where n=1 and m=1;

R″ may mean CH₂, CH₂CH₂, CH₂CH₂CH₂, CH₂CH₂CH₂CH₂, CH(CH₃), CH₂CH(CH₃), C(CH₃)₂, CH(C₂H₅), CH₂CH₂CH(CH₃), CH₂CH(CH₃)CH₂ or

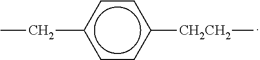

In one embodiment, the sulfur containing organosilicon compound is of formula II, R is ethyl, R′ is C₁₂-C₁₄ alkyl, R″ is CH₂CH₂CH₂, X is SH, n is 1 and m is 1. In one embodiment, the sulfur containing organosilicon compound is Si-363 from Degussa.

In one embodiment, the sulfur containing organosilicon compound is a combination of 3,3′-bis(triethoxypropylsilyl)tetrasulfide and 3-(octanoylthio)-1-propyltriethoxysilane.

The amount of the sulfur containing organosilicon compound in a rubber composition will vary depending on the level of other additives that are used. Generally speaking, the amount of the compound will range from 0.5 to 20 phr. In one embodiment, the amount will range from 1 to 10 phr.

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators and retarders and processing additives, such as oils, resins including tackifying resins and plasticizers, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. In one embodiment, the sulfur-vulcanizing agent is elemental sulfur. The sulfur-vulcanizing agent may be used in an amount ranging from 0.5 to 8 phr, alternatively with a range of from 1.5 to 6 phr. Typical amounts of tackifier resins, if used, comprise about 0.5 to about 10 phr, usually about 1 to about 5 phr. Typical amounts of processing aids comprise about 1 to about 50 phr. Typical amounts of antioxidants comprise about 1 to about 5 phr. Representative antioxidants may be, for example, diphenyl-p-phenylenediamine and others, such as, for example, those disclosed in The Vanderbilt Rubber Handbook (1978), pages 344 through 346. Typical amounts of antiozonants comprise about 1 to 5 phr. Typical amounts of fatty acids, if used, which can include stearic acid comprise about 0.5 to about 3 phr. Typical amounts of zinc oxide comprise about 2 to about 5 phr. Typical amounts of waxes comprise about 1 to about 5 phr. Often microcrystalline waxes are used. Typical amounts of peptizers comprise about 0.1 to about 1 phr. Typical peptizers may be, for example, pentachlorothiophenol and dibenzamidodiphenyl disulfide.

Accelerators are used to control the time and/or temperature required for vulcanization and to improve the properties of the vulcanizate. In one embodiment, a single accelerator system may be used, i.e., primary accelerator. The primary accelerator(s) may be used in total amounts ranging from about 0.5 to about 4, alternatively about 0.8 to about 1.5, phr. In another embodiment, combinations of a primary and a secondary accelerator might be used with the secondary accelerator being used in smaller amounts, such as from about 0.05 to about 3 phr, in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are amines, disulfides, guanidines, thioureas, thiazoles, thiurams, sulfenamides, dithiocarbamates and xanthates. In one embodiment, the primary accelerator is a sulfenamide. If a second accelerator is used, the secondary accelerator may be a guanidine, dithiocarbamate or thiuram compound.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) than the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

The rubber composition may be incorporated in a variety of rubber components of the tire. For example, the rubber component may be a tread (including tread cap and tread base), sidewall, apex, chafer, sidewall insert, wirecoat or innerliner. In one embodiment, the compound is a tread.

The pneumatic tire of the present invention may be a race tire, passenger tire, aircraft tire, agricultural, earthmover, off-the-road, truck tire, and the like. In one embodiment, the tire is a passenger or truck tire. The tire may also be a radial or bias.

Vulcanization of the pneumatic tire of the present invention is generally carried out at conventional temperatures ranging from about 100° C. to 200° C. In one embodiment, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The following examples are presented for the purposes of illustrating and not limiting the present invention. All parts are parts by weight unless specifically identified otherwise.

### Example 1

In this example, two rubber compounds are compared. Sample 1 represents a control sample. Sample 2 is representative of the present invention.

The elastomers were compounded in a multi-stage mix procedure with standard amounts of conventional curatives and processing aids as indicated in Table 1 (all amounts in phr), and cured with a standard cure cycle. Cured samples were evaluated for various physical properties following standard tests protocols as indicated in Table 2. Tires having tread made from compounds of samples 1 and 2 were tested for various performance criteria as shown in Table 3 (values normalized to the control=100)

TABLE 1

| | Inventive | Control |
|---|---|---|
| Sample | 1 | 2 |
| Non-Productive Mix Steps | | |
| Polybutadiene¹ | 30 | 30 |
| SSBR² | 70 | 70 |
| Oil³ | 15 | 5 |
| Silica⁴ | 80 | 86 |
| Carbon black | 0 | 6 |
| alphamethyl styrene resin | 10 | 5 |
| Coupling agent⁵ | 7.0 | 6.8 |
| Waxes⁶ | 1.0 | 1.0 |
| Stearic acid | 3.0 | 3.0 |
| Antidegradant⁷ | 2.5 | 2.5 |
| Productive Mix Step | | |
| Antidegradant⁷ | 0.5 | 0.5 |
| Zinc oxide | 2.5 | 1.5 |
| Sulfur | 1.4 | 1.6 |
| Accelerators⁸ | 5.5 | 4.4 |
| Coupling agent⁹ | 2.0 | 2.0 |

¹Buna CB25, a solution high-cis polybutadiene polymer produced with neodymium catalyst from Lanxess.
²HPR355H from JSR, a functionalized solution polymerized copolymer of butadiene and styrene, having 27% bound styrene and 57% vinyl (BD), Tg (on-set) of −27° C. and a Mooney viscosity of 65 (100° C.).
³TDAE oil.
⁴Zeosil ® Premium 200 MP, synthetic, hydrated, amorphous, precipitated, high aggregate size HDS silica with a surface area of 210 m2/g, from Rhodia.
⁵Bifunctional organosilane (Bis(triethoxysilylpropyl)disulfan).
⁶Microcrystalline and paraffinic.
⁷p-phenylenediamine type.
⁸Sulfenamide and guanidine type.
⁹50 percent by weight bis(triethoxypropylsilyl)tetrasulfide on carbon black; the rubber composition contained therefore 1 phr of carbon black.

TABLE 2

| | Inventive | Control |
|---|---|---|
| Sample | 1 | 2 |
| Physical Properties | | |
| Shore A | 64 | 64 |
| Rebound 23° C. | 37 | 33 |
| Rebound 100° C. | 67 | 62 |
| Elongation, % | 571 | 526 |
| True Tensile, MPa | 113 | 114 |
| Modulus, 300% | 7.9 | 9.6 |
| Tensile Strength, MPa | 16.8 | 18.2 |

TABLE 3

| | Tire Performance | Control |
|---|---|---|
| Sample | 1 | 2 |
| Rolling Resistance | 108 | 100 |
| Wet Braking | 92 | 100 |
| Dry Handling | 104 | 100 |
| Dry Braking | 96 | 100 |

As can be seen from Table 3, the tire having the tread using a compound according to the present invention shows improved rolling resistance and wet performance, with no compromise in dry handling as compared with the control.

While certain representative embodiments and details have been shown for the purpose of illustrating the subject invention, it will be apparent to those skilled in this art that various changes and modifications can be made therein without departing from the scope of the subject invention.

What is claimed is:

1. A pneumatic tire having a tread comprising a vulcanizable rubber composition comprising, expressed as parts by weight per 100 parts by weight of elastomer (phr),
(A) 10 to 40 phr of a polybutadiene rubber having a microstructure comprised of about 96 to about 98 percent cis 1,4-isomeric units, about 1 to about 3 percent trans 1,4-isomeric units and about 0.3 to about 1 percent vinyl 1,2-content; a number average molecular weight (Mn) in a range of from about 230,000 to about 250,000 with a heterogeneity index (Mw/Mn) in a range of from about 1.5/1 to about 2/1, and a Tg in a range of from about −104 to about −109° C.;
(B) 60 to 90 phr of a solution polymerized styrene-butadiene rubber functionalized with an alkoxysilane group and a primary amine group, and is represented by the formula (1) or (2) 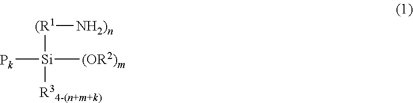
wherein P is a (co)polymer chain of a conjugated diolefin or a conjugated diolefin and an aromatic vinyl compound, R¹ is an alkylene group having 1 to 12 carbon atoms, R² and R³ are each independently an alkyl group having 1 to 20 carbon atoms, an allyl group or an aryl group, n is an integer of 1 or 2, m is an integer of 1 or 2, and k is an integer of 1 or 2, with the proviso that n+m+k is an integer of 3 or 4, 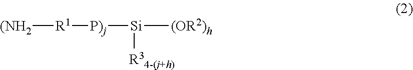
wherein P, R¹, R² and R³ have the same definitions as give for the above-mentioned formula (1), j is an integer of 1 to 3, and h is an integer of 1 to 3, with the provision that j+h is an integer of 2 to 4;
(C) 60 to 100 phr of silica having a CTAB specific surface area (S_{CTAB}) of between 40 and 525 m²/g, a BET specific surface area (S_{BET}) of between 45 and 550 m²/g; and
(D) no more than 5 phr of carbon black.

3. The pneumatic tire of claim 1, wherein the silica has a BET specific surface area (S_{BET}) between 120 and 280 m²/g.

4. The pneumatic tire of claim 1, wherein the silica has a BET specific surface area (S_{BET}) between 150 and 280 m²/g.

5. The pneumatic tire of claim 1, wherein the silica has a BET specific surface area (S_{BET}) between 200 and 260 m²/g.

6. The pneumatic tire of claim 1, wherein the amount of carbon black is no more than 2 phr.

7. The pneumatic tire of claim 1, wherein the amount of carbon black is no more than 1 phr.

8. The pneumatic tire of claim 1, wherein the rubber composition further comprises a low PCA process oil having a polycyclic aromatic content of less than 3 percent by weight as determined by the IP346 method, said low PCA oil selected from mild extraction solvates (MES), treated distillate aromatic extracts (TDAE), or heavy napthenic oils.

9. The pneumatic tire of claim 8, wherein said low PCA oil comprises a mild extraction solvates (MES).

10. The pneumatic tire of claim 8, wherein said low PCA oil comprises treated distillate aromatic extracts (TDAE).

11. The pneumatic tire of claim 1, wherein the rubber composition further comprises a sulfur containing organosilicon compound comprises a compound of the formula:
Z-Alk-Sₙ-Alk-Z I
in which Z is selected from the group consisting of 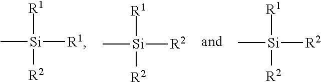
where R¹ is an alkyl group of 1 to 4 carbon atoms, cyclohexyl or phenyl; R² is alkoxy of 1 to 8 carbon atoms, or cycloalkoxy of 5 to 8 carbon atoms; Alk is a divalent hydrocarbon of 1 to 18 carbon atoms and n is an integer of 2 to 8.

12. The pneumatic tire of claim 11, wherein said sulfur containing organosilicon compound comprises at least one of 3,3′-bis(triethoxysilylpropyl)disulfide or 3,3′-bis(triethoxysilylpropyl)tetrasulfide.

13. The pneumatic tire of claim 1, wherein the rubber composition further comprises a sulfur containing organosilicon compound comprising a compound of the formula
G-C(═O)—S—CH₂CH₂CH₂SiX₃ wherein each X is an independently selected RO— group wherein each R is independently selected from the group consisting of hydrogen, alkyl that may or may not contain unsaturation, alkenyl groups, aryl groups, and aralkyl groups, such moieties other than hydrogen having from 1 to 18 carbon atoms, and G is a monovalent alkyl of from 6 to 8 carbon atoms.

14. The pneumatic tire of claim 13, wherein said sulfur containing organosilicon compound comprises 3-(octanoylthio)-1-propyltriethoxysilane.

15. The pneumatic tire of claim 1, wherein the rubber composition further comprises a resin selected from alphamethyl styrene resin and coumarone-indene resin.

16. The pneumatic tire of claim 1, wherein said sulfur containing organosilicon compound comprises at least one compound of formula II or III 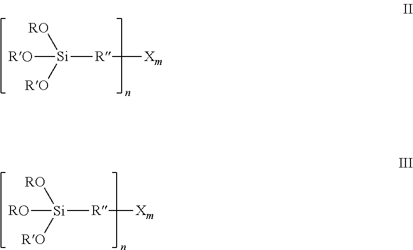
wherein: R is a methyl or ethyl group;
R′ is identical or different and is a C₉-C₃₀ branched or unbranched monovalent alkyl or alkenyl group, aryl group, aralkyl group, branched or unbranched C₂-C₃₀ alkyl ether group, branched or unbranched C₂-C₃₀ alkyl polyether group or R′″₃Si, where R′″ is C₁-C₃₀ branched or unbranched alkyl or alkenyl group, aralkyl group or aryl group, R″ is a branched or unbranched, saturated or unsaturated, aliphatic, aromatic or mixed aliphatic/aromatic divalent C₁-C₃₀ hydrocarbon group;
X is SH where n=1 and m=1, S where n=2 and m=1-10 and mixtures thereof, S(C══O)—R′″ where n=1 and m=1 or H where n=1 and m=1;
R″ may mean CH₂, CH₂CH₂, CH₂CH₂CH₂, CH₂CH₂CH₂CH₂, CH(CH₃), CH₂CH(CH₃), C(CH₃)₂, CH(C₂H₅), CH₂CH₂CH(CH₃), CH₂CH(CH₃)CH₂ or

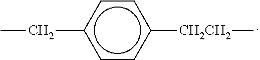

17. The pneumatic tire of claim 16, wherein said sulfur containing organosilicon compound comprise a compound of formula II wherein R is ethyl, R′ is C₁₂-C₁₄ alkyl, R″ is CH₂CH₂CH₂, X is SH, n is 1 and m is 1.
